(19) United States
(12) Patent Application Publication
(10) Pub. No.: US 2017/0122719 A1
(43) Pub. Date: May 4, 2017

(54) SYSTEM FOR DETECTING DEFORMATION OF CUSHION PAD AND PRODUCTION THEREOF

(71) Applicant: TOYO TIRE & RUBBER CO., LTD., Osaka-shi, Osaka (JP)

(72) Inventors: Takeshi Fukuda, Osaka-shi (JP); Junichi Shigeto, Osaka-shi (JP); Hiroaki Ono, Osaka-shi (JP)

(73) Assignee: TOYO TIRE & RUBBER CO., LTD., Osaka-shi, Osaka (JP)

(21) Appl. No.: 15/304,123

(22) PCT Filed: Apr. 13, 2015
(86) PCT No.: PCT/JP2015/061381

§ 371 Date: Oct. 14, 2016

(30) Foreign Application Priority Data
Apr. 15, 2014 (JP) 2014-083928
Sep. 1, 2014 (JP) 2014-177162

(51) Int. Cl. G01B 7/24; B60N 2/00; G01D 5/12; B60R 22/48

(52) U.S. Cl. CPC G01B 7/24; B60R 22/48; B60N 2/002; G01D 5/12; B60R 2022/4858; B60R 2022/4816

(57) ABSTRACT

The present invention provides a cushion pad with improved durability without feeling of a foreign object.

The present invention thus provides a system for detecting a deformation of a cushion pad, comprising;
the cushion pad comprising a magnetic elastomer in which magnetic filler is dispersed in an elastomer and an arithmetic average roughness (Ra) is 0.5 to 10.0 μm, and a soft polyurethane foam which is integrated with the magnetic elastomer by adhesion, and
a magnetic sensor that detects a magnetic change caused by a deformation of the cushion pad. The present invention also provides a production method thereof.

### TECHNICAL FIELD

The present invention is related to a system for detecting deformation of a cushion pad, in particular a system for detecting whether a person sits on a cushion pad used for a car seat, and a production method thereof.

### BACKGROUND ART

There has been practically used a warning system which detects whether a person sits on a seat in a vehicle, such as an automobile and then alerts if the person does not couple a seat belt. The warning system generally gives off an alert when it detects the sitting of the person and simultaneously detects not coupling the seat belt. The apparatus generally comprises a sitting sensor which detects whether a person is sitting on a seat and a sensor which detects not coupling the seat belt with a buckle although the person is seated, which gives off an alert when the uncoupling of the seat belt is detected. The sitting sensor necessitates high durability because it must detect a person sitting down many times. It is also necessary that, when a person is seated, the person does not feel the sensation of any foreign object in the seat.

JP 2012-108113 A (Patent Literature 1) discloses a sitting sensor equipped in a seat, detecting the sitting of a person, which comprises electrodes facing with each other in a cushion material and detects an electric contact of the electrodes. This sensor employs an electrode and should equip wiring. The wiring can be disconnected by receiving a large displacement and gives some problems in durability. In addition, the electrode is generally made of metallic substance which may create a sensation of a foreign object. Even if the electrode is not metallic, the feeling of a foreign object would easily generate from the other substances.

JP 2011-255743 A (Patent Literature 2) discloses an electrostatic capacitance-type sitting sensor which comprises sensor electrodes facing with each other, between which dielectric substance is inserted, and an electrostatic capacitance-type sensor that measures an electrostatic capacity between the electrodes. This sensor also employs electrodes and should equip wiring, which gives rise to durability problems as same with Patent Literature 1. It is also difficult to prevent a sensation of a foreign object.

JP 2007-212196 A (Patent Literature 3) discloses a load detection device for a vehicle seat, which comprises a magnetism generator equipped with a displaceable flexible element and a magnetic sensor, equipped with a fixing element of a flame, having a magnetic impedance element that detects a magnetic field generated by the magnetism generator. Since the magnetism generator includes a magnet having a specified size in this device, it is quite difficult to dispose the magnetism generator near a surface of a cushion material without any foreign object sensation. In order to avoid the foreign object sensation, it is considered that the magnetism generator is disposed inside the cushion material, but this leads to the deterioration of detection accuracy.

JP 2006-014756 A (Patent Literature 4) discloses a biosignal detection device which comprises a permanent magnet and a magnetic sensor. Since the device also employs the permanent magnet which would give a foreign object sensation, it is difficult to place the device near a surface of the cushion material. The displacement of the device inside the cushion material leads to the deterioration of detection accuracy.

### CITATION LIST

### Patent Literature

[PTL 1] JP 2012-108113 A
[FIT 1] JP 2011-255743 A
[FIT 1] JP 2007-212196 A
[FIT 1] JP 2006-014756 A

### SUMMARY OF INVENTION

### Technical Problem

The present invention is to provide a deformation detection system which enhances durability of cushion pad without feeling of foreign object. As the results of the intense study to achieve the above object, the present inventors have found that a magnetic elastomer wherein magnetic filler is dispersed in an elastomer is used, its surface is roughened and is combined with a polyurethane foam, whereby adhesion property is enhanced, thus the present invention having being accomplished.

### Solution to Problem

Accordingly, the present invention provides a system for detecting a deformation of a cushion pad, comprising;

the cushion pad comprising a magnetic elastomer in which magnetic filler is dispersed in an elastomer and an arithmetic average roughness (Ra) is 0.5 to 10.0 μm, and a soft polyurethane foam which is integrated with the magnetic elastomer by adhesion, and

a magnetic sensor that detects a magnetic change caused by a deformation of the cushion pad.

The magnetic elastomer preferably has a maximum height roughness (Rz) of 5.0 to 50.0 μm.

It is preferred that the magnetic elastomer is self-adhered to the soft polyurethane foam.

The magnetic elastomer preferably has a concentration of residual OH group of 0.2 to 0.9 meq/g.

The cushion pas is preferably a seat cushion pad and the deformation to be detected is caused by a sitting of a person.

The present invention also provides a method for producing a system for detecting a deformation of a cushion pad, comprising the cushion pad and a sensor detecting the deformation of the cushion pad, which comprises the steps of:

a step of preparing a magnetic elastomer having an arithmetic average roughness (Ra) of 0.5 to 10.0 μm,

a step of disposing the magnetic elastomer in a mold for a cushion pad,

a step of pouring a raw material of a soft polyurethane foam into the mold

a step of foaming the raw material of the soft polyurethane foam to integrate the soft polyurethane foam with the magnetic elastomer by self-adhesion, thus forming a cushion pad, and

a step of combining the cushion pad with a magnetic sensor that detects a magnetic change caused by a deformation of the cushion pad.

The magnetic elastomer employed for the method of producing the system for detecting a deformation of a cushion pad preferably has a maximum height roughness (Rz) of 5.0 to 50.0 μm.

The present invention further provides a method for producing a system for detecting a deformation of a cushion pad, comprising the cushion pad and a sensor detecting the deformation of the cushion pad, which comprises the steps of:

a step of preparing a magnetic elastomer having an arithmetic average roughness (Ra) of 0.5 to 10.0 μm,

a step of pouring a raw material of a soft polyurethane foam into a mold for a cushion pad, and foaming to form the cushion pad,

a step of integrate the magnetic elastomer with the cushion pad by adhesion, and

a step of combining the cushion pad with a magnetic sensor that detects a magnetic change caused by a deformation of the cushion pad.

In addition, the magnetic elastomer in the above production method preferably has a concentration of a residual OH group of 0.2 to 0.9 meq/g.

### Advantageous Effects of Invention

According to the present invention, since the magnetic filler is dispersed in the elastomer, it can hardly provide a foreign object sensation and would give comfortable feeling when sitting therein, in comparison with that using a solid magnet. In addition, as the magnetic sensor detects a magnetic change caused by the magnetic filler contained in the magnetic elastomer, the magnetic sensor can be disposed separately with a certain distance apart from the magnetic elastomer and can be placed without wiring to connect with an electrode, which does not show any problems, such as cutting wire or poor durability. Further, since wiring to connect with an electrode is not necessary, it is not necessary to place any foreign object in the cushion pad and a production thereof would become easily.

Since the magnetic elastomer is integrated with the soft polyurethane foam by adhesion, the magnetic elastomer is hardly peeled off from the cushion pad and shows excellent durability. The resulted cushion pad is soft and comfortable when a person sitting therein, because the magnetic elastomer has elasticity. In addition, when the magnetic elastomer is integrate-molded with the soft polyurethane foam, the magnetic elastomer has high self-adhesion ability by chemical effects with the soft polyurethane foam because of the presence of urethane bonding in their molecules, as well as it has suitable arithmetic average roughness (Ra) and suitable maximum height roughness (Rz) which shows excellent anchor effect with the soft polyurethane foam and effectively enhances interfacial adhesion strength.

### BRIEF DESCRIPTION OF DRAWINGS

FIG. 1 is a schematic sectional view which shows an embodiment that the system for detecting the deformation of the cushion pad is applied to a seat for a vehicle.

FIG. 2 is a schematic view which shows the function or action of the magnetic elastomer of the present invention.

FIG. 3 shows a schematic perspective view of the cushion pad of the present invention.

### DESCRIPTION OF EMBODIMENTS

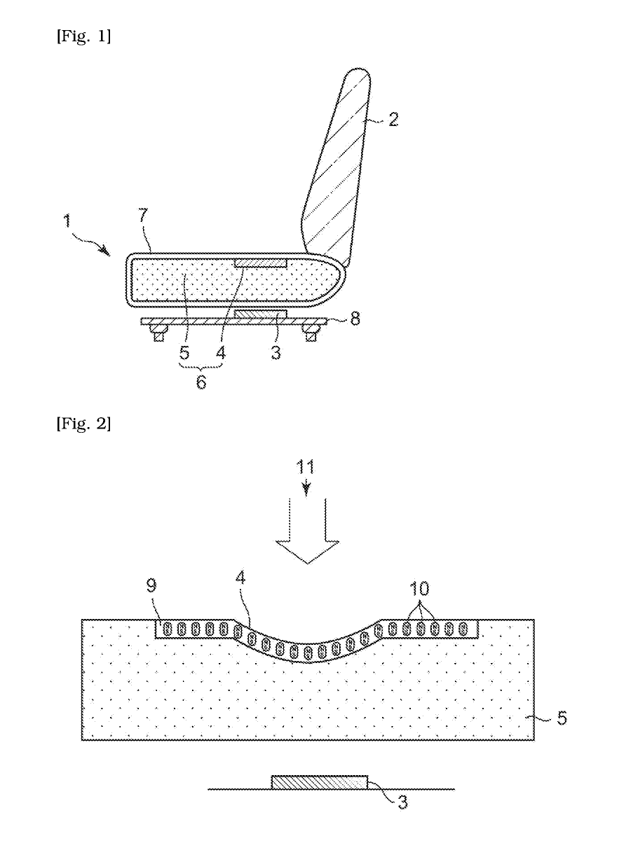

The present invention will be explained in detail by referring FIGS. 1, 2 and 3.

FIG. 1 is a schematic sectional view which shows an embodiment that the system for detecting the deformation of the cushion pad is applied to a seat for a vehicle.

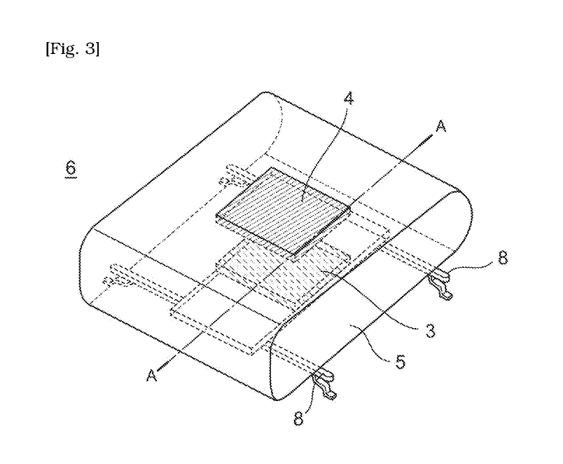

FIG. 2 is a schematic view which shows the function or action of the magnetic elastomer of the present invention.

FIG. 3 shows a schematic perspective view of the cushion pad of the present invention.

The system of the present invention is basically composed of a sitting portion 1, a backrest portion 2 and a magnetic sensor 3, as shown in FIG. 1. The sitting portion 1 is a cushion pad 6 which comprises a magnetic elastomer 4 and a soft polyurethane foam 5, and an outer skin covering the cushion pad 6. The magnetic elastomer is disposed in layer in a portion of the sitting surface of the soft polyurethane foam 5. In the present invention, the magnetic elastomer is integrated with the soft polyurethane foam 5 by adhesion and is hardly peeled off from the soft polyurethane foam 5.

The wording “integration by adhesion” may include an adhesion using an adhesive agent. In the present invention, it includes the following two embodiments. One is a double sided adhesive tape method wherein the magnetic elastomer 4 and the soft polyurethane foam are prepared separately and integrated with a double sided adhesive tape and the other is a self-adhesion method wherein the magnetic elastomer 4 is preliminary prepared and then a raw material of the soft polyurethane foam is foamed in the presence of the magnetic elastomer 4 to integrate the magnetic elastomer 4 with the soft polyurethane foam 5 by self-adhesion. In the present invention, since the magnetic elastomer has suitable arithmetic average roughness (Ra) and suitable maximum height roughness (Rz), the roughness also provides anchor effects in addition to adhesion and enhances interfacial adhesion strength between the magnetic elastomer 4 and the soft polyurethane foam. It is preferred that the magnetic sensor 3 is fixed to a pedestal 8 supporting the seat for a vehicle. The pedestal 8 is fixed to a car body in the case of a car, which is not shown in the figures.

FIG. 3 shows a perspective view of the cushion pad 6 which comprises the magnetic elastomer 4 and the soft polyurethane foam 5, and it further shows the pedestal 8 and the magnetic sensor 3 mounting on the pedestal 8. FIG. 2 schematically shows an embodiment when the A-A line in FIG. 3 is vertically cut. The magnetic elastomer 4 is disposed on an uppermost portion of the polyurethane foam, which can highly receive the deformation when a person is sitting on the seat. FIG. 3 does not show the outer skin 7 which is present on the magnetic elastomer-containing polymer foam 6. The outer skin 7 is generally made of leather, fabric, synthetic resin or the like, which is not limited thereto.

The magnetic elastomer 4 contains many particles of the magnetic filler 10 in the elastomer 9, as shown in FIG. 2. In this context, the term “magnetic elastomer” means an elastomer (especially polyurethane elastomer or silicone elastomer, as mentioned hereinafter), in which the magnetic filler (i.e. inorganic filler having magnetism) is dispersed.

FIG. 2 only shows the magnetic elastomer 4, the soft polyurethane foam 5 and the magnetic sensor 3, which are picked up for explaining its function. In FIG. 2, a pressure 11 is downwardly applied on the elastomer 9. The elastomer 9 is deformed by the pressure 11 and the magnetic filler 10 present in the portion where the pressure 11 is applied is downwardly lowered. The downward change of the magnetic filler 10 makes a magnetic field changed, which is detected by the magnetic sensor 3.

The higher the pressure 11, the bigger the position change of the magnetic filler 10. The lower the pressure 11, the smaller the positon change of the magnetic filler 10. The magnetic change by the position change would also show the strength of the pressure 11 which is also detectable. FIG. 1 shows only one sensor 3, but number of the sensor 3 and its position can be changeable.

As shown in FIG. 2, the magnetic filler 10 is localized with a high concentration in one side of the elastomer 9 and it is preferred that the localized portion is used as the sitting surface. Accordingly, the change of the magnetic filler 10 would become larger and the detection by the magnetic sensor would be easier.

The magnetic filler generally includes rare earth-based, iron-based, cobalt based, nickel-based or oxide-based filler, which can be used in the present invention. The rare earth-based magnetic filler is preferred because it shows high magnetism, but is not limited thereto. Neodymium-based magnetic filler or samarium-based magnetic filler is more preferred. A shape of the magnetic filler 10 is not limited, but includes spherical, flake, needle, columnar or indefinite shape. The magnetic filler may preferably have an average particle size of 0.02 to 500 μm, preferably 0.1 to 400 μm, more preferably 0.5 to 300 μm. If it has an average particle size of less than 0.02 μm, the magnetic properties of the magnetic filler would become poor and if it has an average particle size of more than 500 μm, the mechanical properties (e.g. brittleness) of the magnetic elastomer would become poor.

The magnetic filler 10 may be introduced into the elastomer after it is magnetized, but it is preferred that the magnetic filler is magnetized after it is introduced into the elastomer, because the polarity of the magnetic filler can be easily controlled as shown in FIG. 2 and the detection of magnetism can be easily carried out.

The elastomer 9 can be general elastomer, but preferred is thermosetting elastomer if properties, such as compression permanent strain and the like, are taken into consideration. The magnetic filler is introduced into the elastomer and mixed, followed by subjecting to localization treatment to generate the localization of the magnetic filler.

The elastomer 9 can preferably be polyurethane elastomer or silicone elastomer. When it is polyurethane elastomer, an active hydrogen-containing compound is mixed with the magnetic filler and then an isocyanate compound is mixed to form a mixture solution. It is also conducted by mixing the magnetic filler with the isocyanate compound, into which the active hydrogen-containing compound is mixed, to obtain a mixture solution. The mixture is poured into a mold which has been treated with a mold releasing agent and kept for a determined period, if necessary, to settle the magnetic filler for the localization, followed by heating it to a curing temperature to obtain the magnetic elastomer. When it is silicone elastomer, a precursor of the silicone elastomer is mixed with a solvent and the magnetic filler, and put in a mold, and if necessary kept to settle the magnetic filler, followed by heating it to a curing temperature to obtain the magnetic elastomer. When forming the mixture solution, a solvent can be added thereto, if necessary.

In this context, the isocyanate component and the active hydrogen-containing component to be employed for the polyurethane elastomer are listed hereinafter.

The isocyanate component is not limited and can be anyone that has been employed in the field of polyurethane. Examples of the isocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, and m-xylylene diisocyanate; an aliphatic diisocyanate, such as ethylene diisocyanate, 2,2,4-trimethylhexamethylene diisocyanate, and 1,6-hexamethylene diisocyanate; an alicyclic diisocyanate, such as 1,4-cyclohexane diisocyanate, 4,4′-dicyclohexylmethane diisocyanate, isophorone diisocyanate, and norbornane diisocyanate. The compounds can be used alone or in combination of two or more compounds thereof. In addition, the isocyanate can be modified by urethane modification, allophanate modification, biuret modification, isocyanulate modification or the like.

The active hydrogen-containing compound can be anyone that has been employed in the field of polyurethane. Examples of the active hydrogen-containing compounds are a polyether polyol, such as polytetramethylene glycol, polypropylene glycol, polyethylene glycol and a copolymer of polypropylene oxide and polyethylene oxide; a polyester polyol, such as polybutylene adipate, polyethylene adipate, and 3-methyl-1,5-pentane adipate; a polyester polycarbonate polyol, such as a reaction product of a polyester glycol (e.g. polycaprolactone polyol and polycaprolactone) and an alkylene carbonate; a polyester polycarbonate polyol obtained by reacting ethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof.

In addition to the above-mentioned high molecular weight polyol component, the active hydrogen-containing component can also include a low molecular weight polyol, such as ethylene glycol, 1,2-propylene glycol, 1,3-propylene glycol, 1,4-butanediol, 1,6-hexanediol, neopentyl glycol, 1,4-cyclohexane dimethanol, 3-methyl-1,5-pentanediol, diethylene glycol, triethylene glycol, 1,4-bis(2-hydroxyethoxy)benzene, trimethylolpropane, glycerin, 1,2,6-hexane triol, pentaerythritol, tetramethylol cyclohexane, methyl glucoside, sorbitol, mannitol, dulcitol, sucrose, 2,2,6,6-tetrakis(hydroxymethyl)cyclohexanol, and triethanolamine; and a low molecular weight polyamine, such as ethylenediamine, tolylenediamine, diphenylmethanediamine, diethylenetriamine and the like. These compounds can be used alone or a combination of two or more compounds thereof. A polyamine, including 4,4′-methylenebis(o-chloroaniline)(MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-dimethyltoluene-2,4-diamine, 3,5-diethyltoluene-2,6-diamine, triethyleneglycol-di-p-aminobenzoate, polytetramethyleneoxide-di-p-aminobenzoate, 1,2-bis(2-aminophenylthio)ethane, 4,4′-diamino-3,3′-diethyl-5,5′-dimethyldiphenylmethane, N,N′-di-sec-butyl-4,4′-diaminodiphenylmethane, 4,4′-diamino-3,3′-diethyldiphenylmethane, 4,4′-diamino-3,3′-diethyl-5,5′-dimethyldiphenylmethane, 4,4′-diamino-3,3′-diisopropyl-5,5′-dimethyldiphenylmethane, 4,4′-diamino-3,3′,5,5′-tetraethyldiphenylmethane, m-xylylenediamine, N,N′-di-sec-butyl-p-phenylenediamine, m-phenylenediamine, p-xylylenediamine; and the like, may also be added thereto.

An amount of the magnetic filler in the elastomer can preferably be 1 to 450 parts by weight, more preferably 2 to 400 parts by weight, based on 100 parts by weigh of the elastomer. Amounts of less than 1 part by weight make it difficult to detect magnetic changes and those of more than 450 parts by weight make the elastomer brittle and do not obtain the desired properties.

In the present invention, it is preferred that the magnetic elastomer has a concentration of residual OH group of 0.2 to 0.9 meq/g. The presence of the residual OH group provides self-adhesion with the soft polyurethane foam. Accordingly, in the case of the self-adhesion method as mentioned above, the presence of the residual OH group is important for the self-adhesion. The concentration of residual OH group may preferably be within the range of 0.2 to 0.85 meq/g. If the concentration is less than 0.2 meq/g, the self-adhesion properties with the soft polyurethane foam would be deteriorated. If the concentration is more than 0.9 meq/g, curing may not occur and once it is cured, performance stability is not good. The concentration of residual OH group is determined by dividing an amount (meq) of residual OH group calculated at the time of formulation design, by a total amount (g) of polyurethane elastomer.

In the present invention, it is characterized that the magnetic elastomer has surface roughness which is shown by arithmetic average roughness (Ra) and maximum height roughness (Rz). The magnetic elastomer preferably has an arithmetic average roughness (Ra) of 0.5 to 10.0 μm as surface roughness. The arithmetic average roughness (Ra) means that a standard length is taken off in a direction of an average line from a roughness curve and the average line of the taken portion is made as X axis and Y axis is in a direction of longitudinal magnification, when the roughness curve is expressed as y=f(x), the value obtained by the following mathematical formula 1 is expressed as arithmetic average roughness in a unit of micrometer (μm):

$$Ra = \frac{1}{L} {\int }_{0}^{L} \vert f ( x ) \vert d x \qquad [ Mathematical Formula 1 ]$$

In general, a center line average roughness in a measuring device is shown as the arithmetic average roughness. The measuring device can be SURFTEST SJ-310 available from Mitutoyo Corporation. The magnetic elastomer preferably has an arithmetic average roughness (Ra) of 1.0 to 8.0 μm, more preferably 1.0 to 5.0 μm. Those values of less than 0.5 μm do not show sufficient anchor effects and those of more than 10.0 μm are not sufficient in penetration of a solution of polyurethane foam and may be poor in adhesion.

In addition, it is preferred that the magnetic elastomer of the present invention has a maximum height roughness (Rz) of 5.0 to 50.0 μm. The maximum height roughness (Rz) means that a standard length L is taken off in a direction of an average line from a roughness curve and the maximum height roughness (Rz) is calculated by adding a height of a highest portion in the roughness curve from the average line of the taken portion to a depth to a lowest portion in the roughness curve from the average line of the taken portion. The maximum height roughness (Rz) is also determined by a measuring device which is same with one employed in measuring the arithmetic average roughness (Ra). The magnetic elastomer preferably has a maximum height roughness (Rz) of 10.0 to 50.0 μm, more preferably 15.0 to 35.0 μm. Those values of less than 5.0 μm do not show sufficient anchor effects and those of more than 50.0 μm are not sufficient in penetration of a solution of polyurethane foam and may be poor in adhesion.

The magnetic sensor 3 can be anyone that has generally been used for detecting magnetism. It may include a magnetoresistive element (e.g. a semiconductor magnetoresistive element, an anisotropic magnetoresistive element (AMR), a gigantic magnetoresistive element (GMR) or a tunnel magnetoresistive element (TMR)), a hall element, an inductor, an MI element, a flux gate sensor and the like. The hall element is preferred because it has wide detectable sensitivity region.

In the case of the double sided tape method as mentioned above, the present invention provides a method for producing a system for detecting a deformation of a cushion pad, comprising the cushion pad and a sensor detecting the deformation of the cushion pad, which comprises the steps of:

a step of preparing a magnetic elastomer having an arithmetic average roughness (Ra) of 0.5 to 10.0 μm,

a step of pouring a raw material of a soft polyurethane foam into a mold for a cushion pad, and foaming to form the cushion pad,

a step of integrate the magnetic elastomer with the soft polyurethane foam by adhesion, and

a step of combining the cushion pad with a magnetic sensor that detects a magnetic change caused by a deformation of the cushion pad.

The magnetic elastomer can be produce by formulating the magnetic elastomer when forming elastomer and reacting in a mold. The magnetic elastomer is taken off and its surface is slightly polished with sandpaper having a desired roughness to form a certain range arithmetic average roughness (Ra) and maximum height roughness (Rz). Separate from the magnetic elastomer, a cushion pad is prepared by pouring a raw solution of the soft polyurethane foam into a mold for the cushion pad and foaming. In this case, the mold for the cushion pad needs to have a portion for putting the magnetic elastomer in the resulting cushion pad. The resulting elastomer is adhered with the cushion pad, especially by a double sided adhesion tape, to integrate them to obtain the integrated cushion pad. Since the magnetic elastomer has the desired surface roughness as mentioned above, high anchor effects are obtained by the adhesion, especially by the adhesion using a double sided adhesion tape, and its interfacial adhesion strength is enhanced.

In the case of the self-adhesion method as mentioned above, the present invention provides a method for producing a system for detecting a deformation of a cushion pad, comprising the cushion pad and a sensor detecting the deformation of the cushion pad, which comprises the steps of:

a step of preparing a magnetic elastomer having an arithmetic average roughness (Ra) of 0.5 to 10.0 μm,

a step of disposing the magnetic elastomer in a mold for a cushion pad,

a step of pouring a raw material of a soft polyurethane foam into the mold

a step of foaming the raw material of the soft polyurethane foam to integrate the soft polyurethane foam with the magnetic elastomer by self-adhesion, thus forming a cushion pad, and

a step of combining the cushion pad with a magnetic sensor that detects a magnetic change caused by a deformation of the cushion pad.

The magnetic elastomer is prepared as mentioned above and polished with sandpaper to form a desired arithmetic average roughness (Ra) and maximum height roughness (Rz). The magnetic elastomer which has been polished with the sandpaper is disposed in a mold for a cushion pad, into which a raw solution of the soft polyurethane foam is poured. By foaming the raw material of the polyurethane, the residual OH groups in the magnetic elastomer are reacted with the raw solution of the polyurethane foam or hydrogen-bonded therewith to form a self-adhesion between the soft polyurethane foam and the magnetic elastomer. Since the magnetic elastomer has the desired surface roughness as mentioned above, high anchor effects are obtained and its interfacial adhesion strength is enhanced. Since the surface roughness of the magnetic elastomer shows adhesion effects with the interface between the soft polyurethane foam and the magnetic elastomer, it is preferred that the portions of the magnetic elastomer, which contact with the soft polyurethane foam, should have suitable surface roughness.

In order to obtain suitable and desired arithmetic average roughness (Ra) and maximum height roughness (Rz), sandpaper of #120, #240, #400, #600 or #1,000 is preferably employed. If the sandpaper has higher roughness or lower roughness, the arithmetic average roughness (Ra) and maximum height roughness (Rz) of suitable range are not obtained and do not show anchor effects, thus enhancing possibility of peeling off the magnetic elastomer.

The raw solution of the soft polyurethane foam comprises a polyisocyanate component and an active hydrogen-containing compound (such as a polyol, water or the like). Examples of the polyisocyanate components and the active hydrogen-containing compounds are listed hereinafter.

The polyisocyanate component can be anyone that has been used in the field of polyurethane. Examples of the polyisocyanate components are an aromatic diisocyanate, such as 2,4-toluene diisocyanate, 2,6-toluene diisocyanate, 2,2′-diphenylmethane diisocyanate, 2,4′-diphenylmethane diisocyanate, 4,4′-diphenylmethane diisocyanate, 1,5-naphthalene diisocyanate, p-phenylene diisocyanate, m-phenylene diisocyanate, p-xylylene diisocyanate, m-xylylene diisocyanate and the like. It can also be polynuclear compounds of diphenylmethane diisocyanate (crude MDI). The polyisocyanate compound can further be an aliphatic diisocyanate, such as ethylene diisocyanate, 2,2,4-trimethylhexamethylene diisocyanate and 1,6-hexamethylene diisocyanate; an alicyclic diisocyanate, such as 1,4-cyclohexane diisocyanate, 4,4′-dicyclohexylmethane diisocyanate, isophorone diisocyanate, norbornane diisocyanate; and the like. These can be used alone or in combination with two or more isocyanates thereof. In addition, the isocyanate can be modified by urethane modification, allophanate modification, biuret modification, isocyanulate modification or the like.

The active hydrogen-containing compound can be anyone that has generally been used in the field of polyurethane. Examples of the active hydrogen-containing compounds are a polyether polyol, such as polytetramethylene ether glycol, polypropylene glycol, polyethylene glycol and a copolymer of propylene oxide and ethylene oxide; a polyester polyol, such as polybutylene adipate, polyethylene adipate, and 3-methyl-1,5-pentane adipate; a polyester polycarbonate polyol, such as a reaction product of polyester glycol (e.g. polycaprolactone polyol or polycaprolactone) and alkylene carbonate; a polyester polycarbonate polyol obtained by reacting polyethylene carbonate with a polyhydric alcohol to form a reaction mixture, followed by reacting the reaction mixture with an organic dicarboxylic acid; a polycarbonate polyol obtained by ester-exchange reacting a polyhydroxyl compound with an aryl carbonate; and the like. The active hydrogen-containing compounds can be used alone or a combination of two or more compounds thereof. The concrete examples of the active hydrogen-containing compounds include, for example EP 3028, EP 3033, EP 828, POP 3128, POP 3428 and POP 3628, commercially available from Mitsui Chemical Inc.; and the like.

When producing the soft polyurethane foam, other components, such as crosslinking agent, foam stabilizer, catalyst and the like can be employed and they are not limited thereto.

The crosslinking agent may include triethanolamine, diethanolamine or the like. The foam stabilizer may include SF-2962, SRX-274C, 2969T and the like, available from Dow Corning Toray Co., Ltd. Examples of the catalysts are Dabco 33LV available from Air Products Japan Co., Ltd., Toyocat ET, SPF2, MR available from Tosoh Corporation, and like.

In addition, an additive, such as water, toner, flame retardant or the like can be suitably employed if necessary.

Examples of the flame retardants are CR 530 or CR 505 available from Daihachi Chemical Industry Co., Ltd.

The cushion pad obtained by the above method, is combined with a magnetic sensor to obtain a system for detecting a deformation of cushion pad according to the present invention. The cushion pad includes a layer of the magnetic elastomer and the magnetic elastomer is deformed to generate a change of magnetism. The magnetism change is detected by the magnetic sensor to find the person sitting on the seat. In the case of a system for detecting coupling a seat belt of an automobile, it detects the person sitting on the seat and emits a warning during not coupling the seat belt. Once the seat belt is coupled, the warning is not emitted.

### EXAMPLES

The present invention is further explained based on the following examples which, however, are not construed as limiting the present invention to their details.

### Preparation Example 1

### Synthesis of Prepolymer A having Terminal Isocyanate End Group

A reaction vessel was charged with 85.2 parts by weight of polyol A (polyoxypropylene glycol obtained by adding propylene oxide to glycerin of an initiator, OH value 56 and functionality 3) and dehydrated at a reduced pressure with stirring for one hour. The reaction vessel was then changed to nitrogen atmosphere. Next, 14.8 parts by weight of toluene diisocyanate (2,4 configuration=100%, NCO %=48.3%; available from Mitsui Chemicals Inc.) was added to the reaction vessel and reacted for 3 hours at a temperature of 80° C. in the reaction vessel to synthesize a prepolymer A having a terminal isocyanate group (NCO %=3.58%).

### Preparation Example 2

### Synthesis of Prepolymer B having Terminal Isocyanate Group

A reaction vessel was charged with 81.2 parts by weight of polyol C (polyoxypropylene glycol obtained by adding propylene oxide to pentaerythritol of an initiator, OH value of 75 and functionality 3) and dehydrated at a reduced pressure with stirring for an hour. The reaction vessel was then changed to nitrogen atmosphere. Next, 18.8 parts by weight of toluene diisocyanate (2,4 configuration=100% and NCO %=48.3%) was added to the reaction vessel and reacted for 3 hours at a temperature of 80° C. to obtain a prepolymer B having a terminal isocyanate group (NCO %=4.55%).

### Example 1

A mixture solution of 213.0 parts by weight of polyol A and 0.38 parts by weight of bismuth octylate (PUCAT 25 available from Nihon Kagaku Sangyo Co., Ltd.) was mixed with 730.3 parts by weight of neodymium based filler (MF-15P available from Aichi Steel Corporation, average particle size=133 μm) to form a filler dispersion. The filler dispersion was defoamed in a reduced pressure and mixed with 100.0 parts by weight of the prepolymer A which has been defoamed, and then mixed using a planetary centrifugal mixer (available from Thinky Corporation) and defoamed. The reaction solution was poured dropwise on a PET film, which had been treated with a mold releasing agent and also had a spacer of 1.0 mm, and then was adjusted by a nip roller to a 1.0 mm thickness. It was then kept at 80° C. for 1 hour to cure, thus obtaining a magnetic filler dispersed polyurethane elastomer. The resulting elastomer was then magnetized at 1.3 T using a magnetizing apparatus (available from Denshijiki Industry Co., Ltd.) to obtain a magnetic elastomer.

The resulting magnetic elastomer was subjected to polishing of the surfaces other than the sitting surface, using #400 sandpaper. The polished surfaces were subjected to a measurement of arithmetic average roughness (Ra) and maximum height roughness (Rz), using SURFTEST SJ-310 available from Mitutoyo Corporation and the results are shown in Table 1.

Next, 60.0 parts by weight of a polypropylene glycol (available from Mitsui Chemicals Inc. as EP-3028; OH value 28), 40.0 parts by weight of a polymer polyol (available from Mitsui Chemicals Inc. as POP-3128; OH value 28), 2.0 parts by weight of diethanolamine (available from Mitsui Chemicals Inc.), 3.0 parts by weight of water, 1.0 part by weight of a foam stabilizer (available from Dow Corning Toray Co., Ltd. as SF-2962) and 0.5 parts by weight of an amine catalyst (available from Air Products Japan Co., Ltd. as Dabco 33LV) were mixed with stirring to obtain a mixture A which was controlled to a temperature of 23° C. Separately, a mixture of toluene diisocyanate and crude MDI (80/20 weight ratio; available from Mitsui Chemicals Inc. as TM-20; NCO %=44.8%) was controlled to a temperature of 23° C. to obtain a mixture B.

The magnetic elastomer obtained above was cut to 50 mm square and was placed in a mold for cushion pad such a position that the unpolished surface faced down and heated to a mold temperature of 62° C. Into the mold, a raw material obtained by mixing the mixture A with the mixture B so as to become NCO index=1.0 was poured using a high pressure foaming machine and foamed and cured at a mold temperature 62° C. for 5 minutes to obtain a magnetic elastomer-integrated cushion pad. The cushion pad was subjected to a determination of property stability (%), as explained hereinafter. The results are shown in Table 1.

Measurement of Property Stability

The resultant cushion pad was subjected to durability test of 500,000 times and the property stability was determined by a change rate of sensor performance against its initial value. The sensor performance was determined by a change rate of output voltage of a Hall element at the time of applying a pressure of 10 kPa, using a pressure indenter having 40 mmq for applying pressures.

### Examples 2 to 11 and Comparative Example 1

A magnetic elastomer was prepared by using the formulation shown in Table 1 and a cushion pad was also obtained as generally described in Example 1. The resulting cushion pad was subjected to the measurement of arithmetic average roughness (Ra) and maximum height roughness (Rz) and the evaluation of the property stability. The results are shown in Table 1. It is noted that, in Example 11, the soft polyurethane foam was not integrated with the magnetic elastomer and they were separately prepared and adhered thereto by a double sided adhesive tape, to obtain a cushion pad which was subjected to the same evaluation. It is also noted that, in Comparative Example 1, the magnetic elastomer was not polished by sandpaper and that, in Comparative Example 2, it was polished by #60 sandpaper and the surface was too rough.

TABLE 1

| | | | Examples | | | | | | |
|---|---|---|---|---|---|---|---|---|---|
| | | | 1 | 2 | 3 | 4 | 5 | 6 | 7 |
| Formulation | Prepolymer | Prepolymer A | 100.0 | 100.0 | 100.0 | 100.0 | | 100.0 | 100.0 |
| | | Prepolymer B | | | | | 100.0 | | |
| | Curing agent | Polyol A | 213.0 | 213.0 | 213.0 | 71.0 | | 213.0 | 213.0 |
| | | Polyol B | | | | 71.0 | | | |
| | | Polyol C | | | | | 406.3 | | |
| | Magnetic filler | Neodymium based | 730.3 | 730.3 | 730.3 | 564.7 | 1181.4 | 730.3 | 730.3 |
| | Catalyst | Bithmus octylate | 0.38 | 0.38 | 0.38 | 0.29 | 0.61 | 0.38 | 0.38 |
| | | Lead octylate | | | | | | | |

| | | | | | | | | |
|---|---|---|---|---|---|---|---|---|
| | NCO index | 0.40 | 0.40 | 0.40 | 0.60 | 0.20 | 0.40 | 0.40 |
| | Residual OH group | 0.41 | 0.41 | 0.41 | 0.24 | 0.83 | 0.41 | 0.41 |
| | concentration (meq/g) | | | | | | | |
| Production | Adhession process | IM | IM | IM | IM | IM | IM | IM |
| conditions | Sandpaper employed | #400 | #240 | #600 | #400 | #400 | #120 | #800 |
| Results | Ra (μm) | 2.03 | 4.86 | 1.23 | 2.24 | 1.86 | 7.86 | 0.89 |
| | Rz (μm) | 23.56 | 34.12 | 15.37 | 21.78 | 15.96 | 48.72 | 8.78 |
| | Property stability (%) | 9.4 | 12.9 | 6.4 | 8.1 | 7.1 | 16.4 | 18.9 |

| | | | Examples | | | | Comparative Examples | |
|---|---|---|---|---|---|---|---|---|
| | | | 8 | 9 | 10 | 11 | 1 | 2 |
| Formulation | Prepolymer | Prepolymer A | 100.0 | 100.0 | | 100.0 | 100.0 | 100.0 |
| | | Prepolymer B | | | 100.0 | | | |
| | Curing agent | Polyol A | 213.0 | | | 213.0 | 213.0 | 213.0 |
| | | Polyol B | | 106.5 | | | | |
| | | Polyol C | | | 541.5 | | | |
| | Magnetic filler | Neodymium based | 730.3 | 481.8 | 1496.8 | 730.3 | 730.3 | 730.3 |
| | Catalyst | Bithmus octylate | 0.38 | 0.25 | | 0.38 | 0.38 | 0.38 |
| | | Lead octylate | | | 8.02 | | | |

| | | | | | | | |
|---|---|---|---|---|---|---|---|
| | NCO index | 0.40 | 0.80 | 0.15 | 0.40 | 0.40 | 0.40 |
| | Residual OH group | 0.41 | 0.10 | 0.93 | 0.41 | 0.41 | 0.41 |
| | concentration (meq/g) | | | | | | |
| Production | Adhession process | IM | IM | IM | DSAT | IM | IM |
| conditions | Sandpaper employed | #1000 | #400 | #400 | #400 | Not used | #60 |
| Results | Ra (μm) | 0.95 | 3.89 | 6.19 | 2.03 | 0.34 | 12.87 |
| | Rz (μm) | 12.37 | 35.84 | 45.81 | 23.56 | 2.96 | 68.21 |
| | Property stability (%) | 20.4 | 15.8 | 14.9 | 23.7 | 25.6 | 27.6 |

In Table 1, IM means integrate molding and DSAT means double sided adhesive tape.

In the Table, polyol B is a polyoxypropylene glycol obtained by adding propylene oxide to propylene glycol of an initiator, OH value 56 and functionality 2.

As is apparent from Table 1, the cushion pads satisfying claim 1 of the present invention are excellent in property stability. However, in Comparative Examples 1 and 2 having outside ranges in arithmetic average roughness (Ra), the property stability shows more than 25%.

In Example 6, the values of Ra and Rz are high and the property stability is more than 15%, but the pads are in the range of usable. In Examples 7 and 8 which show an embodiment of low values of Ra and Rz, the property stability is more than 15%, but it is still in the range of usable. In Example 9, since the resulting OH group concentration is low and adhesion performance is also insufficient because of chemical effect, the property stability is not good, but is usable. In Example 10, elasticity of the magnetic elastomer is too low and Ra is large when its surface is polished by sandpaper, the property stability is near 15%. In Example 11 wherein the cushion pad was obtained not by integral molding, but by a double sided adhesion tape, the property stability is as high as 23.7%, but it withstands general use.

### INDUSTRIAL APPLICABILITY

The system for detecting a deformation of cushion pad of the present invention can be applied to a seat for a vehicle and is excellent in durability so that it endures a long period of use. In addition, the resulted cushion pad is soft and comfortable even a person sits a long period of time, because the magnetic elastomer has elasticity.

### REFERENCE SIGNS LIST

1 Sitting portion
2 Backrest portion
3 Magnetic sensor
4 Magnetic elastomer
5 Soft polyurethane foam
6 Cushion pad
7 Outer skin
8 Pedestal
9 Elastomer
10 Magnetic filler
11 Pressure

1. A system for detecting a deformation of a cushion pad, comprising;
the cushion pad comprising a magnetic elastomer in which magnetic filler is dispersed in an elastomer and an arithmetic average roughness (Ra) is 0.5 to 10.0 μm, and a soft polyurethane foam which is integrated with the magnetic elastomer by adhesion, and
a magnetic sensor that detects a magnetic change caused by a deformation of the cushion pad.

2. The system for detecting the deformation of the cushion pad according to claim 1, wherein the magnetic elastomer has an arithmetic average roughness (Ra) of 1.0 to 8.0 μm.

3. (canceled)

4. The system for detecting the deformation of the cushion pad according to claim 1, wherein the magnetic elastomer has a maximum height roughness (Rz) of 5.0 to 50.0 μm.

5.-6. (canceled)

7. The system for detecting the deformation of the cushion pad according to claim 1, wherein the magnetic elastomer is integrated with the soft polyurethane foam by self-adhesion.

8. The system for detecting the deformation of the cushion pad according to claim 1, wherein the magnetic elastomer has a concentration of residual OH group of 0.2 to 0.9 meq/g.

9. (canceled)

10. The system for detecting the deformation of the cushion pad according to claim 1, wherein the cushion pad is applied to a seat and the deformation to be detected is caused by a sitting of a person.

11. A system for detecting a deformation of a cushion pad, comprising the cushion pad and a sensor detecting the deformation of the cushion pad, wherein the cushion pad is composed of a magnetic elastomer in which magnetic filler is dispersed in an elastomer and an arithmetic average roughness (Ra) is 0.5 to 10.0 μm, and a soft polyurethane foam which is integrated with the magnetic elastomer by adhesion, and the sensor is a magnetic sensor that detects a magnetic change caused by a deformation of the magnetic elastomer associated with the cushion pad.

12. A method for producing a system for detecting a deformation of a cushion pad, comprising the cushion pad and a sensor detecting the deformation of the cushion pad, which comprises the steps of:
a step of preparing a magnetic elastomer having an arithmetic average roughness (Ra) of 0.5 to 10.0 μm,
a step of pouring a raw material of a soft polyurethane foam into a mold for a cushion pad, and foaming to form the cushion pad,
a step of integrate the magnetic elastomer with the cushion pad by adhesion, and
a step of combining the cushion pad with a magnetic sensor that detects a magnetic change caused by a deformation of the cushion pad.

13. The method according to claim 12, wherein the magnetic elastomer has an arithmetic average roughness (Ra) of 1.0 to 8.0 μm.

14. (canceled)

15. The method according to claim 12, wherein the magnetic elastomer has a maximum height roughness (Rz) of 5.0 to 50.0 μm.

16.-17. (canceled)

18. The method according to claim 12, wherein the cushion pad is applied to a seat and the deformation to be detected is caused by a person sitting.

19. A method for producing the system for detecting a deformation of a cushion pad of claim 1, comprising the cushion pad and a sensor detecting the deformation of the cushion pad, which comprises the steps of:
a step of preparing a magnetic elastomer having an arithmetic average roughness (Ra) of 0.5 to 10.0 μm,
a step of disposing the magnetic elastomer in a mold for a cushion pad,
a step of pouring a raw material of a soft polyurethane foam into the mold
a step of foaming the raw material of the soft polyurethane foam to integrate the soft polyurethane foam with the magnetic elastomer by self-adhesion, thus forming a cushion pad, and
a step of combining the cushion pad with a magnetic sensor that detects a magnetic change caused by a deformation of the cushion pad.

20. The method according to claim 19, wherein the magnetic elastomer has an arithmetic average roughness (Ra) of 1.0 to 8.0 μm.

21. (canceled)

22. The method according to claim 19, wherein the magnetic elastomer has a maximum height roughness (Rz) of 5.0 to 50.0 μm.

23.-24. (canceled)

25. The method according to claim 19, wherein the magnetic elastomer has a concentration of residual OH group of 0.2 to 0.9 meq/g.

26. (canceled)

27. The method according to claim 19, wherein the cushion pad is applied to a seat and the deformation to be detected is caused by a sitting of a person.
